(19) United States
(12) Patent Application Publication
(10) Pub. No.: US 2017/0039487 A1
(43) Pub. Date: Feb. 9, 2017

(54) SUPPORT VECTOR MACHINE LEARNING SYSTEM AND SUPPORT VECTOR MACHINE LEARNING METHOD

(71) Applicant: HITACHI, LTD., Tokyo (JP)

(72) Inventors: Ken Naganuma, Tokyo (JP); Susumu Serita, Tokyo (JP); Yoshinori Sato, Tokyo (JP); Hisayoshi Sato, Tokyo (JP); Masayuki Yoshino, Tokyo (JP)

(73) Assignee: HITACHI, LTD., Tokyo (JP)

(21) Appl. No.: 15/303,092

(22) PCT Filed: Apr. 11, 2014
(86) PCT No.: PCT/JP2014/060533

§ 371 Date: Oct. 10, 2016

(51) Int. Cl. G06N 99/00; G06F 21/60

(52) U.S. Cl. CPC G06N 99/005; G06F 21/602

(57) ABSTRACT

[Problem] To make it possible to reliably conceal a label of a supervisory signal when support vector machine learning is performed.

[Solution] An analysis executing apparatus that performs support vector machine learning, stores a set of learning data including a feature vector and a label encrypted using an additive homomorphic encryption scheme, which are subjected to the support vector machine learning, and performs update processing with a gradient method on the encrypted learning data using an additive homomorphic addition algorithm.

### CROSS REFERENCE TO PRIOR APPLICATIONS

This application is a U.S. National Phase application under U.S.C. §371 of International Application No. PCT/JP2014/060533, filed on Apr. 11, 2014. The International Application was published in Japanese on Oct. 15, 2015 as WO 2015/155896A1 under PCT Article 21 (2) . The contents of the above applications are hereby incorporated by reference.

### TECHNICAL FIELD

The present invention relates to a support vector machine learning system and a support vector machine learning method.

### BACKGROUND ART

In recent years, big data business has been getting popular, which collects and analyzes an enormous volume of data to extract valuable knowledge. Since analyzing the enormous volume of data requires a large-capacity storage, a high-speed CPU, and a system that performs a distributed control for these devices, it is conceivable to leave the analysis to external resources such as a cloud service. However, in the case where data processing is outsourced, problems concerning privacy are raised. For this reason, a privacy-preserving analysis technique is receiving attention in which data are sent to an outsourcing service for analysis after a privacy protection technique such as encryption is applied to the data. For example, in Non Patent Literature 1, when support vector machine learning is performed, a client of an analysis provides an executor of the analysis with feature vectors that have been linearly transformed with a random matrix, and the learning is performed using reduced SVM.

### CITATION LIST

### Non Patent Literature

[NPL 1] “Privacy-Preserving Outsourcing Support Vector Machines with Random Transformation” by Keng-Pei Lin and Ming-Syan Chen, Jul. 25, 2010, KDD2010 Proceedings of the 16th ACM SIGKDD international conference on Knowledge discovery and data mining, pages 363-372

### SUMMARY OF INVENTION

### Technical Problem

However, the technique disclosed in NPL 1 allows the executor of the analysis to understand what classification has been made because information on whether each label is positive or negative is provided to the executor. In addition, since linear transformation is used for concealing feature vectors, if the feature vectors can be associated before and after the transformation and the number of the associated combinations is the same as the number of dimensions of the feature vector space, it is possible for the executor to identify feature vectors before the linear transformation from the feature vectors after the linear transformation.

The present invention is made in view of the above background, and an object thereof is to provide a support vector machine learning system and a support vector machine learning method that are capable of reliably concealing a label of a supervisory signal when support vector machine learning is performed.

### Solution to Problem

A main aspect of the present invention in order to solve the above problems is a support vector machine learning system that performs support vector machine learning, including a learning data management apparatus and a learning apparatus. The learning data management apparatus includes: a learning data storage part that stores a set of learning data including a label and a feature vector, the set of learning data being subjected to the support vector machine learning; an encryption processing part that encrypts the label of the learning data using an additive homomorphic encryption scheme; and a learning data transmitting part that transmits encrypted learning data including the encrypted label and the feature vector to the learning apparatus. The learning apparatus includes: a learning data receiving part that receives the encrypted learning data; and an update processing part that performs update processing with a gradient method on the encrypted learning data using an additive homomorphic addition algorithm.

Other problems and solutions to the problems disclosed in this application will be apparent with reference to the section of description of embodiments and the drawings.

### Advantageous Effects of Invention

According to the present invention, it is possible to reliably conceal a label of a supervisory signal when support vector machine learning is performed.

### BRIEF DESCRIPTION OF DRAWINGS

FIG. 1 is an exemplary diagram illustrating a hypersurface that maximizes a margin and results from support vector machine learning.

FIG. 2 is a diagram illustrating a configuration example of a data learning analysis system according to a first embodiment.

FIG. 3 is a diagram illustrating a hardware configuration example of an analysis requesting apparatus and an analysis executing apparatus according to the first embodiment.

FIG. 4 is a diagram illustrating a software configuration example of the analysis requesting apparatus according to the first embodiment.

FIG. 5 is a diagram illustrating a component configuration example of the analysis executing apparatus according to the first embodiment.

FIG. 6 is a diagram illustrating a process procedure according to the first embodiment.

FIG. 7 is a diagram for explaining data for learning, in other words, a set of secret feature vectors according to the first embodiment.

FIG. 8 is a diagram illustrating a process procedure of a learning process according to the first embodiment.

FIG. 9 is an exemplary diagram illustrating a solution resulting from a secret learning process according to the first embodiment.

FIG. 10 is an exemplary diagram illustrating a hypersurface resulting from the secret learning process according to the first embodiment.

FIG. 11 is a diagram illustrating a process procedure of a learning process according to a second embodiment.

FIG. 12 is an exemplary diagram illustrating a solution resulting from a secret learning process according to the second embodiment.

### DESCRIPTION OF EMBODIMENTS

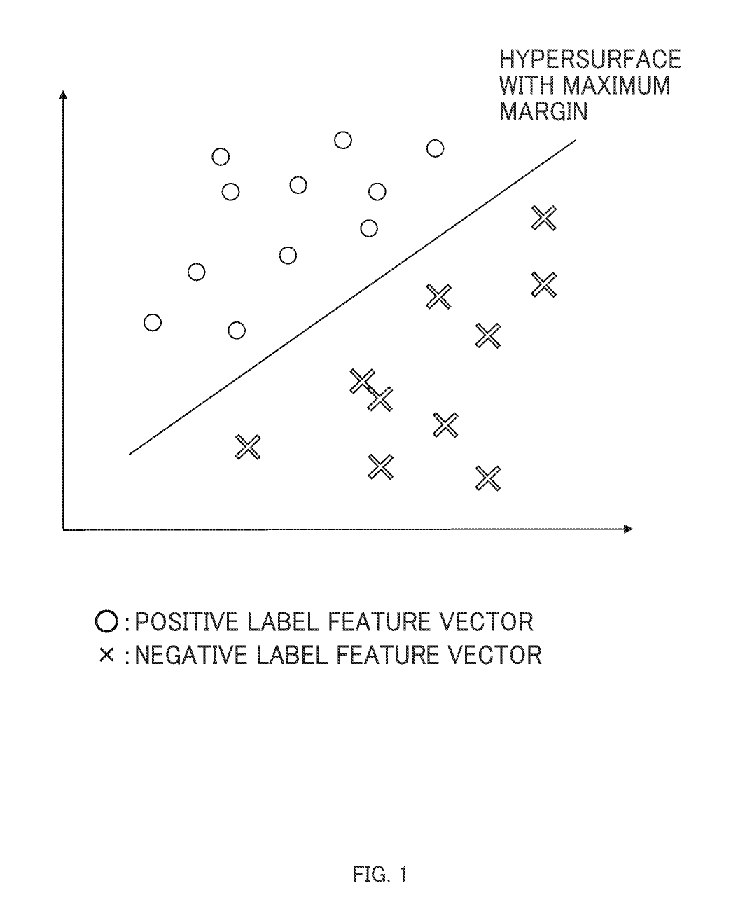

Hereinafter, descriptions are provided in detail for a data learning analysis system according to an embodiment of the present invention, based on FIGS. 1 to 6. The data learning analysis system of the embodiment is intended to improve the security when generating a pattern classifier using support vector machine learning (hereinafter also referred to as SVM learning) by (a) encrypting data used for learning (learning data) and (b) adding dummy data to the set of learning data to reliably conceal the labels.

==Definition==

First, terminology of the encryption method and the data analysis used in the embodiment is defined. In the embodiment, the same one of additive homomorphic encryption schemes is used throughout the embodiment.

### (1) Additive Homomorphic Encryption Scheme (Algorithm)

The additive homomorphic encryption scheme used in the embodiment is an encryption algorithm having additive property among encryption schemes having homomorphism (in this embodiment, public key encryption schemes are assumed). For example, additive homomorphic encryption schemes have additive property between encrypted texts, in addition to asymmetric property to an encryption key and a decryption key, which ordinary public key encryption schemes have. In other words, using two sets of encrypted text, it is possible to calculate the encrypted text the plaintext of which is the arithmetic sum (hereinafter simply referred to as addition or sum, and the operator symbol used for the arithmetic sum is denoted by “+”) of two sets of plaintext corresponding to the two sets of encrypted text, by using only public information (without using a secret key or the plaintext). Accordingly, when the encrypted text of plaintext m is E(m), the formula E (m₁)+E (m₂)=E (m₁+m₂) holds true. Also in the following descriptions, E(m) represents the encrypted text of plaintext m.

### (2) Algorithm for Generating Secret Key/Public Key for Additive Homomorphic Encryption

The algorithm for generating a secret key/a public key for additive homomorphic encryption means a secret key/a public key generating algorithm defined by the additive homomorphic encryption algorithm described above. The command input of the algorithm is a security parameter and a key seed, and the output thereof is a secret key/a public key with a certain bit length.

### (3) Encryption Algorithm for Additive Homomorphic Encryption

The encryption algorithm for additive homomorphic encryption means the encryption algorithm defined by the additive homomorphic encryption algorithm described above. The input of the encryption algorithm for additive homomorphic encryption is plaintext and a public key, and the output thereof is the encrypted text.

### (4) Decryption Algorithm for Additive Homomorphic Encryption

The decryption algorithm for additive homomorphic encryption means the decryption algorithm defined by the additive homomorphic encryption algorithm described above. The input of the decryption algorithm for additive homomorphic encryption is encrypted text and a secret key, and the output thereof is the plaintext corresponding to the encrypted text.

### (5) Addition Algorithm for Additive Homomorphic Encryption

The addition algorithm for additive homomorphic encryption means the algorithm to perform addition operation between sets of encrypted text, which is defined by the additive homomorphic encryption algorithm described above. The command input of this algorithm is multiple sets of encrypted text, and the output thereof is the encrypted text corresponding to the sum total of the multiple sets of plaintext, each corresponding to the multiple sets of encrypted text. For example, if the command input is encrypted text E(100) corresponding to 100 and encrypted text E(200) corresponding to 200, the output is encrypted text E(300) corresponding to 300 (100+200).

(6) Support Vector Machine (hereinafter also referred to as SVM)

The support vector machine is one of discrimination methods using supervised learning. When the following set of learning data are given as a subject of SVM learning:

D={(xᵢ, yᵢ)|xᵢ ∈ R^{m}, yᵢ ∈ {−1, 1} i=1, 2, . . . , n},

the SVM calculates the hyperplane or the hypersurface having the maximum margin among the hyperplanes or the hypersurfaces that separate the xᵢ vectors specified by yᵢ=1 and the xᵢ vectors specified by yᵢ=−1 within R^{m}. Here, the margin of a hyperplane or a hypersurface is a distance from the xᵢ vector closest to the hyperplane or the hypersurface among the xᵢ vectors specified by yᵢ=1 and the xᵢ vectors specified by yᵢ=−1. In addition, in the embodiment, each xᵢ vector is called a feature vector.

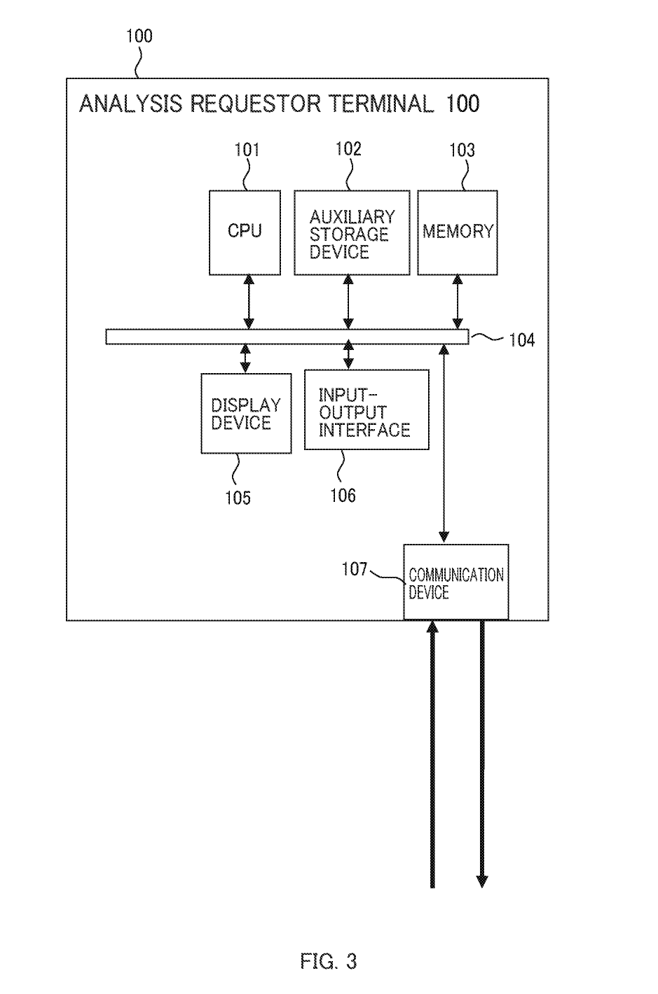

Moreover, the feature vectors xᵢ specified by yᵢ=1 are called positive label feature vectors, and the feature vectors xᵢ specified by yᵢ=−1 are called negative label feature vectors. Meanwhile, yᵢ is a class to classify data with the pattern classifier (see FIG. 1) and is called a label. Note that although in this embodiment, descriptions are provided using a set of learning data that can be separated by a hyperplane or a hypersurface as illustrated in FIG. 3 (a hard margin problem), the present invention is not limited thereto, and the same method is applicable to a non-separable case (a soft margin problem). In addition, although descriptions are provided hereafter using an example in which the data set is separable by a hyperplane, the present invention is not limited thereto, and is also applicable to an example in which the data set is separable by a nonlinear hypersurface using a conventional kernel method.

### (7) SVM Learning

When the set of learning data described above:

D={(xᵢ, yᵢ)|xᵢ ∈ R^{m}, yᵢ ∈ {−1, 1}i=1, 2, . . . , n}

is given, an algorithm to obtain the hyperplane that maximizes the margin within R^{m} is called an SVM learning algorithm, and the problem of obtaining the hyperplane is called an SVM problem. More specifically, this problem comes down to a problem of searching for real number coefficients (a₁, a₂, . . . , aₘ) ∈ R^{m} that maximizes an objective function L(a₁, a₂, . . . , aₙ). Here the objective function L is expressed as the following formula:

$$L ( {a}_{1} , {a}_{2} , … , {a}_{n} ) = 2 {\sum }_{i = 1}^{n} {a}_{i} - {\sum }_{i , j = 1}^{n} {a}_{i} {a}_{j} {y}_{i} {y}_{j} 〈 {x}_{i} , {x}_{j} 〉 . \qquad ( 1 )$$

Here, all the aᵢ≧0, and the following constraint condition is satisfied:

$${\sum }_{i = 1}^{n} {a}_{i} {y}_{i} = 0. \qquad ( 2 )$$

### (8) Gradient Method

The gradient method is an algorithm to search for a solution on an optimization problem based on information on the gradient of a function. On the above SVM problem, the optimum solution (a₁, a₂, . . . , aₙ) that maximizes the objective function L is obtained using the gradient method.

The i-th component L′ᵢ of the gradient vector of the function L is expressed as follows:

$$2 - 2 {y}_{i} {\sum }_{j = 1}^{n} {a}_{j} {y}_{j} 〈 {x}_{i} , {x}_{j} 〉 . \qquad ( 3 )$$

Accordingly, it is possible to obtain an optimum solution or an approximate solution thereof by recursively updating the coefficients (a₁, a₂, . . . , aₙ) using the gradient method with an update rate y as below:

$${a}_{i} ← {a}_{i} - γ ( 2 - 2 {y}_{i} {\sum }_{j = 1}^{n} {a}_{j} {y}_{j} 〈 {x}_{i} , {x}_{j} 〉 ) . \qquad ( 4 )$$

### SUMMARY OF INVENTION

As described above, in the data learning analysis system of the embodiment, when the SVM learning is performed, (a) learning data are encrypted, and (b) dummy data are added to the learning data.

### (a) Encryption of Learning Data

In the embodiment, the label yᵢ of learning data is encrypted and provided to an analysis executing apparatus 200, which executes the SVM: learning. By doing so, the contents of the label yᵢ (whether it is +1 or −1) are concealed from the analysis executing apparatus 200 side. Concealing the contents of the label yᵢ makes it difficult for the analysis executing apparatus 200 to give significant meaning to the learning data.

The additive homomorphic encryption scheme is used for the algorithm for encryption. As described above, as for encrypted data using the additive homomorphic encryption scheme, it is possible to perform addition of encrypted text as encrypted data (without decryption), and the result of decryption of added encrypted text agrees to the result of adding corresponding sets of plaintext. When the gradient method is used to calculate the optimum solution (or an approximate solution) of the SVM learning, the above update formula (4) can be modified to be the following formula (5):

$${a}_{i} {y}_{i} ← {a}_{i} {y}_{i} - γ ( 2 {y}_{i} - 2 {\sum }_{j = 1}^{n} {a}_{j} {y}_{j} 〈 {x}_{i} , {x}_{j} 〉 ) . \qquad ( 5 )$$

Here, if (a₁, a₂, . . . , aₙ), (x₁, x₂, . . . , xₙ), and γ have been known, the right-hand side of the update formula (5) is the sum of the scalar products in regard to yᵢ. Accordingly, even though encrypted text E(y₁) by the additive homomorphic encryption is given instead of yᵢ, and plaintext yᵢ is not given, it is possible to calculate the update formula (5) by utilizing the additive property of the additive homomorphic encryption. In other words, the following formula (6) can be calculated as an update formula:

$$E ( {a}_{i} {y}_{i} ) ← {a}_{i} E ( {y}_{i} ) - γ ( 2 E ( {y}_{i} ) - 2 {\sum }_{j = 1}^{n} {a}_{j} E ( {y}_{j} ) 〈 {x}_{i} , {x}_{j} 〉 ) . \qquad ( 6 )$$

In the data learning analysis system of the embodiment, SVM learning is performed using the above formula (6) as the update formula in the analysis executing apparatus 200. This makes it possible to perform SVM learning using the encrypted text E(yᵢ) without providing the analysis executing apparatus 200 with the plaintext on the label yᵢ.

Note that in the case where the additive homomorphic encryption scheme does not have multiplicative property like Paillier's encryption scheme, multiplication of the encrypted text E (y) is necessary when two or more times of recursive updates are performed using the update formula (6). Hence, in the embodiment, the update is performed only once.

### (b) Addition of Dummy Data

Meanwhile, dummy data are added to the set of learning data in this embodiment. By doing so, on the analysis executing apparatus 200 side which are provided with the set of learning data, it is difficult to even estimate significant meaning given to the learning data, for example, by using the deviation of the distribution of the learning data.

The dummy data added to the set of learning data are given a label yᵢ of 0, which is neither +1 nor −1. Giving 0 as a label makes the terms concerning the label yᵢ of the dummy data become 0 in the right-hand side of the update formula (5), and does not affect the update formula (5). The same applies to the update formula (6), which utilizes the additive homomorphic encryption scheme having additive property.

On the other hand, since the labels are encrypted in a side of an analysis executor, it is possible to make the analysis executor unable to determine whether or not learning data are dummy data. In addition, by adding dummy data such that the set of learning data comes close to a uniform distribution, it will be more difficult to give meaning to the learning data.

Hereinafter, descriptions are provided in detail.

### First Embodiment

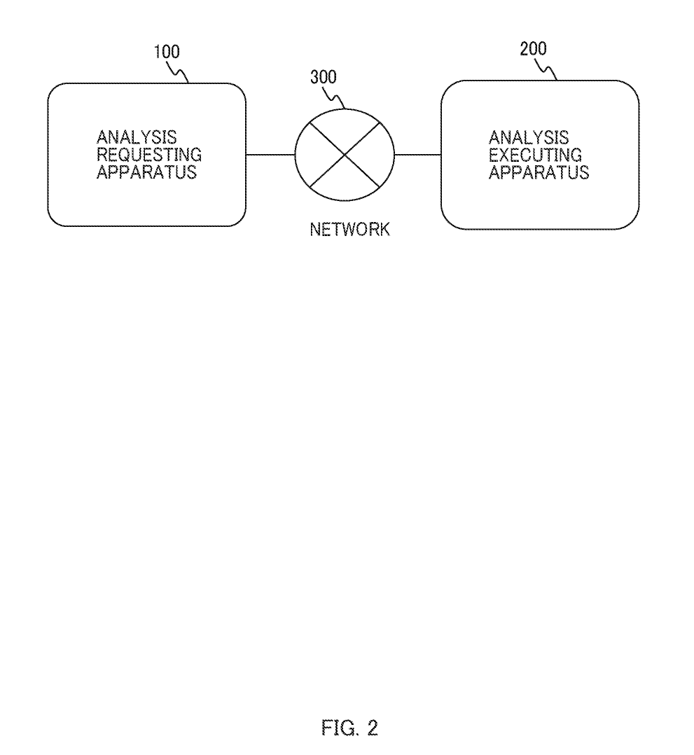

FIG. 2 is a schematic diagram of a data learning analysis system according to an embodiment of the present invention. As illustrated in FIG. 2, the data learning analysis system of this embodiment includes an analysis requesting apparatus 100 and an analysis executing apparatus 200. The analysis requesting apparatus 100 manages learning data. The analysis executing apparatus 200 performs processes related to SVM learning.

The analysis requesting apparatus 100 and the analysis executing apparatus 200 are designed to be capable of sending and receiving information to and from each other through a network 300. The network 300 is, for example, the Internet or a local area network (LAN), which is built using, for example, Ethernet (registered trademark), optical fiber, wireless communication channels, public telephone networks, dedicated telephone

The analysis requesting apparatus 100 transmits a set of learning data to the analysis executing apparatus 200 through the network 300. The analysis executing apparatus 200 performs SVM learning on the learning data received from the analysis requesting apparatus 100, and transmits the result of the SVM learning (hereinafter referred to as learning result) to the analysis requesting apparatus 100 through the network 300. The analysis requesting apparatus 100 generates a pattern classifier using the learning result.

### ==Hardware Configuration==

FIG. 3 is a schematic hardware diagram of the analysis requesting apparatus 100. As illustrated in FIG. 3, the analysis requesting apparatus 100 includes a CPU 101, an auxiliary storage device 102, a memory 103, a display device 105, an input-output interface 106, and a communication device 107, which are coupled with each other via an internal signal line 104. Program codes are stored in the auxiliary storage device 102. The program codes are loaded into the memory 103 and executed by the CPU 101.

Meanwhile, the analysis executing apparatus 200 also includes the same hardware configuration illustrated in FIG. 2 as the analysis requesting apparatus 100 does.

### ==Component Configuration of Analysis Requesting Apparatus==

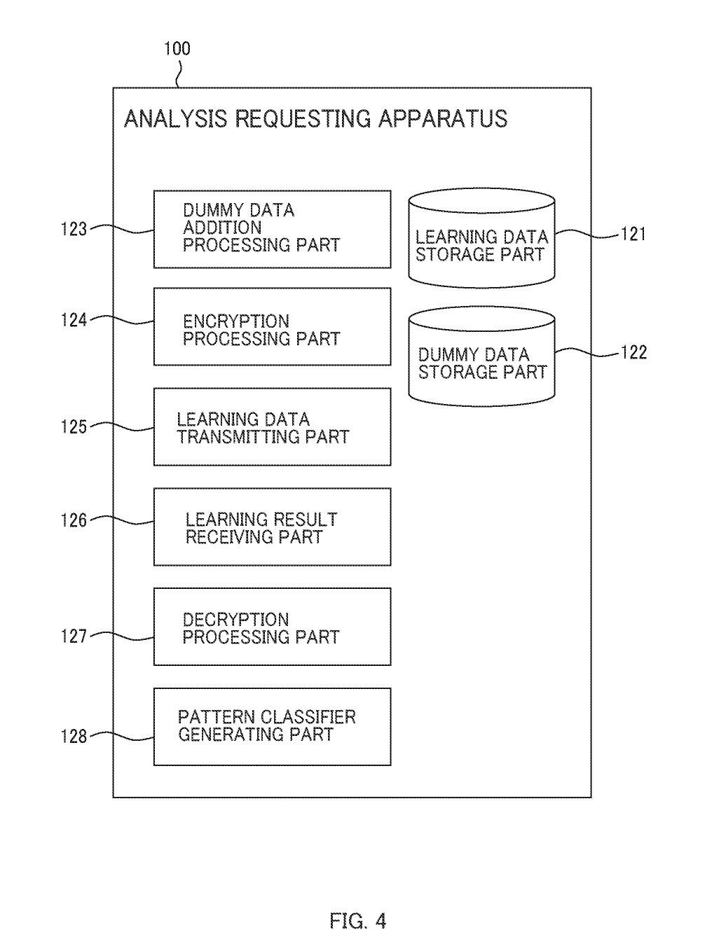

FIG. 4 is a schematic component configuration of the analysis requesting apparatus 100 using the hardware components as referenced in connection with FIG. 3. The analysis requesting apparatus 100 includes a learning data storage part 121, a dummy data storage part 122, a dummy data addition processing part 123, an encryption processing part 124, a learning data transmitting part 125, a learning result receiving part 126, a decryption processing part 127, and a pattern classifier generating part 128.

The learning data storage part 121 and the dummy data storage part 122 are implemented as part of the storage areas provided by the auxiliary storage device 102 and the memory 103 included in the analysis requesting apparatus 100. The dummy data addition processing part 123, the encryption processing part 124, the learning data transmitting part 125, the learning result receiving part 126, the decryption processing part 127, and the pattern classifier generating part 128 are implemented by the CPU 101, included in the analysis requesting apparatus 100, loading the program codes stored in the auxiliary storage device 102 into the memory 103 and executing the program codes.

The learning data storage part 121 stores a set of learning data D. Note that the set of learning data is expressed as follows as described above:

D={(xᵢ, yᵢ)|xᵢ ∈ R^{m}, yᵢ ∈ {−1, 1} i=1, 2, . . . , n}

The dummy data addition processing part 123 adds dummy data to the set of learning data D. The dummy data are data including the label y of “0.” The dummy data addition processing part 123 adds the dummy data such that the distribution of the feature vectors included in the set of learning data D is uniform in the feature space. The dummy data addition processing part 123 may receive input of feature vectors from the user that makes the distribution of the feature vectors uniform. Alternatively, the dummy data addition processing part 123 may partition the feature space, select partitions in which the number of feature vectors included in the partition is small, and generate feature vectors such that the feature vectors are included in one or more selected partitions until it is judged using a chi-square test or the like that the feature space has become uniform, for example. Furthermore, the dummy data addition processing part 123 may randomly rearrange (change the subscript i randomly) the learning data (feature vectors with labels). The dummy data addition processing part 123 stores information indicating the dummy data (for example, the subscript i that indicates dummy data) in the dummy data storage part 122.

The encryption processing part 124 generates the encrypted text E(y) by encrypting the label y of the learning data using the encryption algorithm for the additive homomorphic encryption and generates learning data in which the encrypted text E(y) is used instead of the label y (hereinafter referred to as secret learning data, and represented by E (D)). The secret learning data E(D) is expressed as follows:

E(D)={(xᵢ,E(yᵢ))|xᵢ ∈ R^{m}, yᵢ ∈ {−1, 1, 0} i=1, 2, . . . , N}.

The learning data transmitting part 125 transmits the secret learning data to the analysis executing apparatus 200.

The learning result receiving part 126 receives the processing result of the SVM learning transmitted from the analysis executing apparatus 200. As will be described later, in this embodiment, what the analysis requesting apparatus 100 receives from the analysis executing apparatus 200 as the processing result is not real number coefficients (a₁, a₂, . . . , aₘ) ∈ R^{m}, but encrypted text {E(aᵢyᵢ)|i=1, 2, . . . , N} (hereinafter referred to as secret learning result) of values obtained by multiplying the coefficients by the labels {aᵢyᵢ|i=1, 2, . . . , N} (hereinafter referred to as learning result).

The decryption processing part 127 decrypts the secret learning result and obtains (a₁y₁, a₂y₂, a_{N}y_{N}) The decryption processing part 127 also identifies the dummy data in the learning result decrypted based on the information stored in the dummy data storage part 122, and extracts (a₁, a₂, . . . , aₙ) by removing the dummy data from the learning result. In addition, when a coefficient becomes negative, the decryption processing part 127 may use as the learning result an orthogonal projection vector obtained by orthogonally projecting the vector (a₁, a₂, . . . , aₙ) onto the orthogonal complement of (y₁, y₂, . . . , yₙ)

The pattern classifier generating part 128 generates a pattern classifier using the coefficients (a₁, a₂, . . . , aₘ) ∈ R^{m}. Note that for the pattern classifier generating method, the same method as with that used when a general SVM learning is performed is employed and descriptions thereof are omitted in this description.

### ==Component Configuration of Analysis Executing Apparatus==

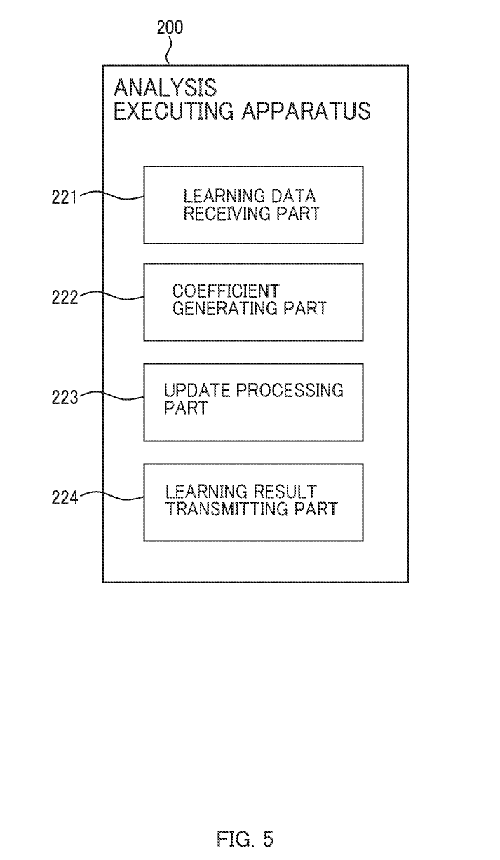

FIG. 5 is a schematic component configuration of the analysis executing apparatus 200 using the hardware components as referenced in connection with FIG. 3. The analysis executing apparatus 200 includes a learning data receiving part 221, a coefficient generating part 222, an update processing part 223, and a learning result transmitting part 224. Note that the coefficient generating part 222, the update processing part 223, and the learning result transmitting part 224 are implemented by the CPU 101, included in the analysis executing apparatus 200, loading the program codes stored in the auxiliary storage device 102 into the memory 103 and executing the program codes.

The learning data receiving part 221 receives the set of secret learning data transmitted from the analysis requesting apparatus 100.

The coefficient generating part 222 generates the coefficients (a₁, a₂, . . . , a_{N}) of the objective function L. In this embodiment, the coefficient generating part 222 generates a random number N times and uses the numbers as the coefficients. However, predetermined initial values (for example, all the aᵢ′s can be set to 0) may be set for the coefficients.

The update processing part 223 performs update processing using the update formula (6) described above. The update processing part 223 uses an addition process using the additive homomorphic encryption scheme for the operation represented by the operator symbol “+” concerning the update formula (6). In addition, in this embodiment, it is assumed that an additive homomorphic encryption scheme having no multiplicative property, such as Paillier's encryption scheme, is used as an additive homomorphic encryption scheme. Accordingly, the update processing part 223 generates the set of encrypted text E(aᵢyᵢ) obtained by providing the update formula (6) with randomly set coefficients and the set of secret learning data, so as to use it as the secret learning result without any processing.

The learning result transmitting part 224 transmits the secret learning result to the analysis requesting apparatus 100.

### ==Process Procedure==

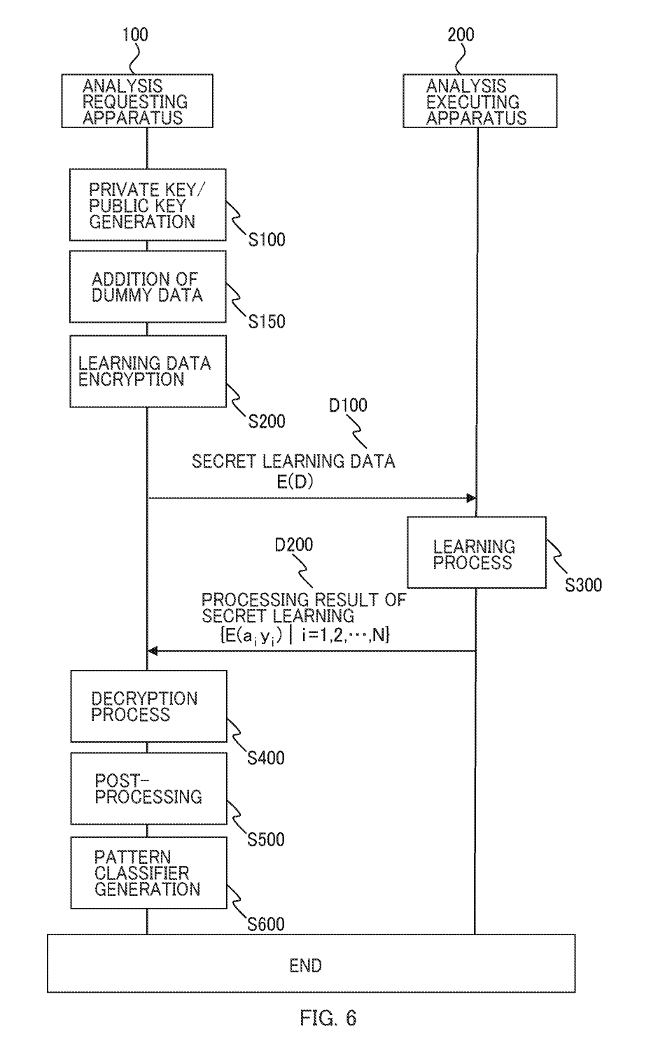

FIG. 6 is a diagram illustrating a process procedure executed in the data learning analysis system of this embodiment.

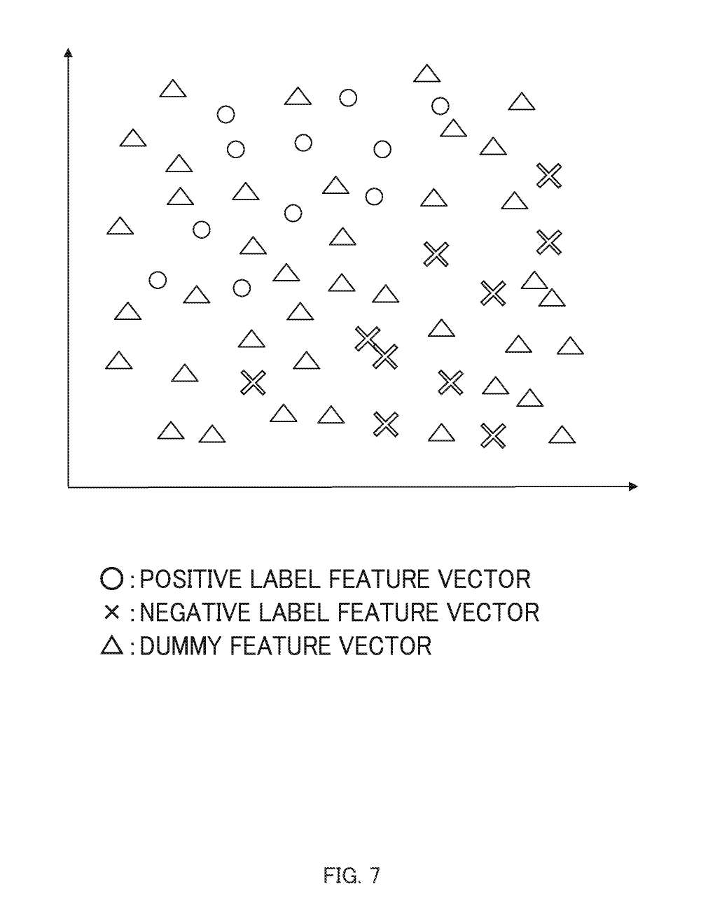

First, in the analysis requesting apparatus 100, the encryption processing part 124 generates a secret key/a public key to be used hereafter using the algorithm for generating a secret key/a public key based on the additive homomorphic encryption scheme (S100). Then, the dummy data addition processing part 123 adds the dummy data including the label yᵢ=0 and the feature vectors {(xᵢ,0) i=n+1, N} of the dummy to the set of learning data D={(xᵢ, yᵢ)|xᵢ ∈ R^{m}, yᵢ∈ {−1,1} i=1, 2, . . . , n} stored in the learning data storage part 121 to generate the new set of learning data D={(xᵢ,yᵢ)|xᵢ ∈ R^{m}, yᵢ ∈ {−1,1, 0} i=1, 2, . . . , N} (S150). Here, the dummy data addition processing part 123 may randomly rearrange the learning data. FIG. 7 illustrates the feature space in which the set of dummy feature vectors having the label 0 is added to the sets of positive and negative feature vectors. In FIG. 7, the vectors corresponding to the symbols “◯” are the positive label feature vectors, the vectors corresponding to the symbols “X” are the negative label feature vectors, and the vectors corresponding to the symbols “Δ” are the dummy feature vectors. As illustrated in FIG. 7, the dummy data addition processing part 123 adds the dummy data such that the distribution of the feature vectors comes close to a uniform one.

Next, the encryption processing part 124 generates the encrypted text E(yᵢ) using the encryption algorithm for the additive homomorphic encryption with the public key generated in (S100) using the label yᵢ as plaintext and generates the secret learning data E(D)={(xᵢ,E(yᵢ))|xᵢ ∈ R^{m}, yᵢ ∈ {−1, 1, 0} i=1, 2, . . . , N} using the set of learning data D={(xᵢ,yᵢ)|xᵢ ∈0 R^{m}, yᵢ ∈ {−1, 1, 0} i=1, 2, . . . , N} (S200). The learning data transmitting part 125 transmits the secret learning data (D100) to the analysis executing apparatus 200.

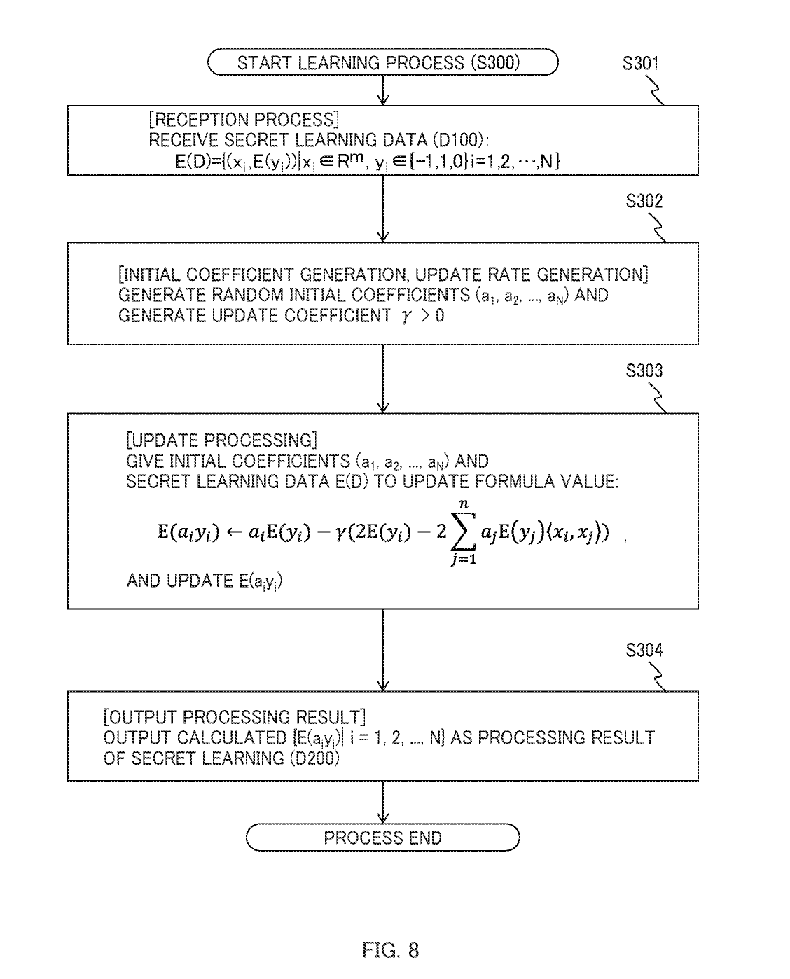

The analysis executor terminal 200, which has received the secret learning data (D100), performs the learning process illustrated in FIG. 8 (S300). The learning result transmitting part 224 returns the learning result {E(aᵢyᵢ)|i=1, 2, . . . , N} to the analysis requesting apparatus 100 as the secret learning result (D200).

In the analysis requesting apparatus 100, the learning result receiving part 126 receives the secret learning result (D200) transmitted from the analysis executing apparatus 200, and the decryption processing part 127 decrypts the secret learning result (D200) using the secret key generated in (S100) and obtains the learning result (a₁y₁, a₂y₂, . . . , a_{N}y_{N}) (S400). The decryption processing part 127 removes the results corresponding to the dummy data from (a₁y₁, a₂y₂, . . . , a_{N}y_{N}) and finally generates the column of coefficients (a₁, a₂, . . . , aₙ). If a coefficient aᵢ<0, the decryption processing part 127 changes the value of aᵢ such that aᵢ=0. As described above, the post-processing ends (S500). Here, if necessary, the decryption processing part 127 may orthogonally project the vector (a₁, a₂, . . . , aₙ) onto the orthogonal complement of (y₁, y₂, . . . , yₙ) such that the following formula is satisfied:

$${\sum }_{i = 1}^{n} {a}_{i} {y}_{i} = 0 ,$$

and may treat the orthogonal projection vector as the column of coefficients (a₁, a₂, . . . , aₙ). The pattern classifier generating part 128 generates a pattern classifier using the column of coefficients (a₁, a₂, . . . , aₙ) (S600).

FIG. 8 is a diagram illustrating the process procedure of the learning process in (S300) of FIG. 6.

The learning data receiving part 221 receives the secret learning data (D100), in other words, E(D)={(xᵢ,E(yᵢ))|xᵢ ∈ R^{m}, yᵢ ∈ {−1, 1, 0} i=1, 2, . . . , N} (S301), and the coefficient generating part 222 generates random coefficients (a₁, a₂, . . . , a_{N}) to use them as initial coefficients and sets the update coefficient γ>0 (S302). Note that the coefficient generating part 222 uses a predetermined constant such as, for example (γ=0.001) or any other suitable constant in this embodiment.

Next, the update processing part 223 calculates the above update formula (6) in regard to the initial coefficients (a₁, a₂, . . . , a_{N}) and the secret learning data (D100) (S303). The learning result transmitting part 224 transmits the processing result of the secret learning {E(aᵢyᵢ)|i=1, 2, . . . N} (D200) calculated from the update formula (6) to the analysis requesting apparatus 100 (S304).

As described above, in the data learning analysis system of this embodiment, applying the additive homomorphic encryption scheme to the gradient method makes it possible to perform the SVM learning using the gradient method with the labels remaining encrypted (without decryption). Accordingly, it is possible to conceal the labels added to the feature vectors as a supervisory signal from the analysis executing apparatus 200 side.

In addition, in the data learning analysis system of this embodiment, the labels are encrypted instead of being linearly transformed. For example, in the case of the learning method disclosed in NPL 1, because all the feature vectors are linearly transformed using the same matrix, for example, in the case where combinations of a feature vector after the secret process and its original feature vector are leaked out, and the number of the leaked combinations agrees to the dimension of the feature vector space, it may be possible to identify the matrix used for the transformation and thereby identify the original feature vectors. However, since additive homomorphic encryption schemes such as Paillier's encryption scheme are resistant to chosen plaintext/ciphertext attack, even if the combinations of feature vectors, the number of which is equal to or larger than the dimension of the feature vector space, are leaked out, it will be difficult to identify the labels. Thus, this makes it possible to reliably conceal the labels from the analysis executing apparatus 200 side and the improvement of the security can be expected.

In addition, in the data learning analysis system of this embodiment, since the labels are encrypted in addition to adding the dummy data to the set of learning data, it is difficult to estimate the labels from uneven distribution of feature vectors, or the like. Thus, the security can be improved. In the case where the distribution of feature vectors is uneven, it is conceivable that the labels maybe estimated from the distribution. However, in the data learning analysis system of this embodiment, since the dummy data are added such that the feature vectors come close to a uniform distribution, it is difficult to estimate information on the original feature vectors from the set of the encrypted feature vectors. Thus, it is possible to reliably conceal the labels from the analysis executing apparatus 200 side. Consequently, the security can be improved more.

In addition, in the data learning analysis system of this embodiment, since the label of the dummy data is “0”, it is possible to eliminate effect of adding the dummy data at the update processing with the gradient method. Moreover, since the label of the dummy data is encrypted, it is impossible to estimate from the encrypted data that the effect is eliminated. Thus, it is possible to reliably conceal the learning data from the analysis executing apparatus 200 side.

### Second Embodiment

Next, a second embodiment is described.

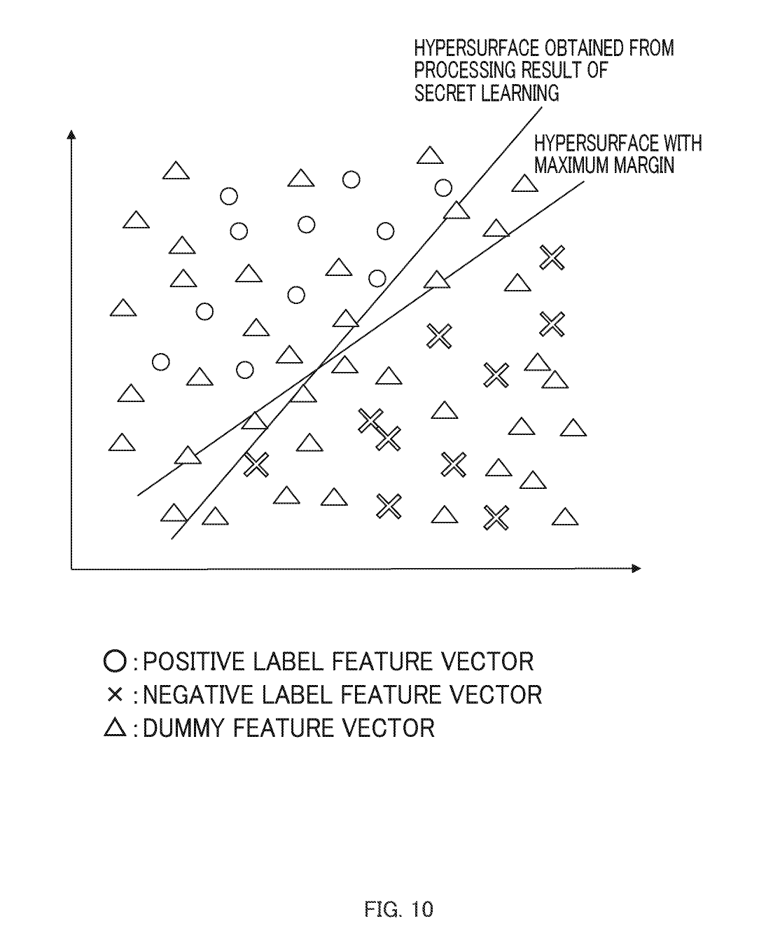

At the learning process (S300) in the first embodiment, the analysis executing apparatus 200 updates the initial coefficients using the gradient method only once (S303). Generally, in the case where the update is performed only once in the gradient method, an obtained solution is not necessarily the optimum solution as illustrated in FIG. 7. Hence, the hypersurface obtained from the secret learning result (D200) that has been updated only once may not agree with the hypersurface obtained from the optimum solution, which maximizes the margin, as illustrated in FIG. 10, and are dependent on the coefficients (a₁, a₂, . . . , a_{N}) randomly selected as the initial coefficients.

To address this, in the second embodiment, k initial values (a₁, a₂, . . . , a_{N}) are prepared to perform the update processing, and by obtaining the sum of the update results E(aᵢyᵢ), the degree of dependence on the initial values is reduced.

From the first embodiment, modifications have been made only on the learning process (S300), and the other process procedure is the same as that of the first embodiment. Hence, descriptions are provided herein only for the learning process (S300).

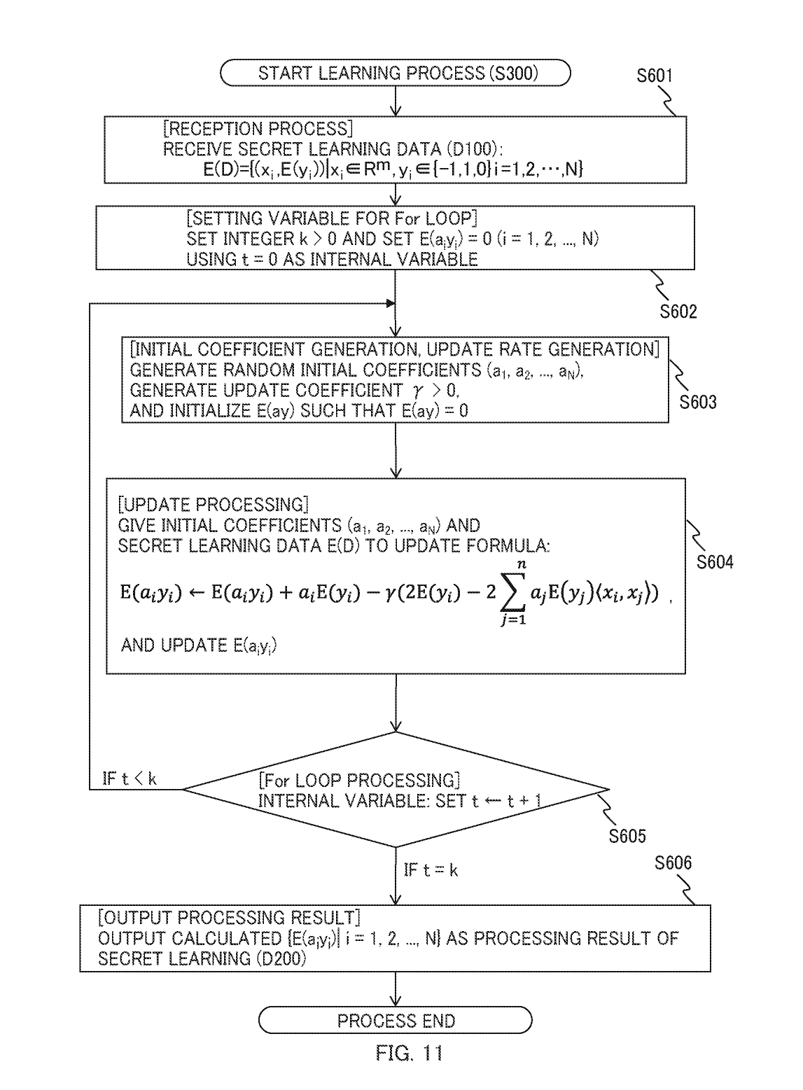

FIG. 11 is a process procedure of the learning process (S300) in the second embodiment.

The learning data receiving part 221 receives the secret learning data (D100), in other words, E(D)={(xᵢ,E(yᵢ))|xᵢ ∈ R^{m}, yᵢ ∈ {−1, 1, 0} i=1, 2, . . . , N} (S601), and the coefficient generating part 222 determines the number k of initial values and sets an internal variable t=0. The value k only needs to be an integer larger than 0 and may also be a random integer. The coefficient generating part 222 may select the largest possible value, depending on the computation resource of the analysis executing apparatus 200 (S602). The coefficient generating part 222 generates the random coefficients (a₁, a₂, . . . , a_{N}) and uses them as the initial coefficients as well as generates the update coefficient y>0 and sets the secret learning result E(aᵢyᵢ) to 0 for i=1, 2, . . . , N for the initialization (S603). Note that also in this embodiment, the same constant (γ=0.001) is used for γ as in the first embodiment.

Next, the update processing part 223 gives the initial coefficients (a₁, a₂, . . . , a_{N}), the secret learning data (D100), and the secret learning result {E(aᵢyᵢ)|i=1, 2, . . . , N} to the following update formula:

$$E ( {a}_{i} {y}_{i} ) ← E ( {a}_{i} {y}_{i} ) + {a}_{i} E ( {y}_{i} ) - γ ( 2 E ( {y}_{i} ) - 2 {\sum }_{j = 1}^{n} {a}_{j} E ( {y}_{j} ) 〈 {x}_{i} , {x}_{j} 〉 ) , \qquad ( 7 )$$

and updates the secret learning result E(aᵢyᵢ) (S604). p The update processing part 223 increments the internal variable t. If t<k, the process is returned to (S603). If t=k, the learning result transmitting part 224 transmits the secret learning result {E(aᵢyᵢ)|i=1, 2, . . . , N} calculated with the above update formula (7) to the analysis requesting apparatus 100 (S606).

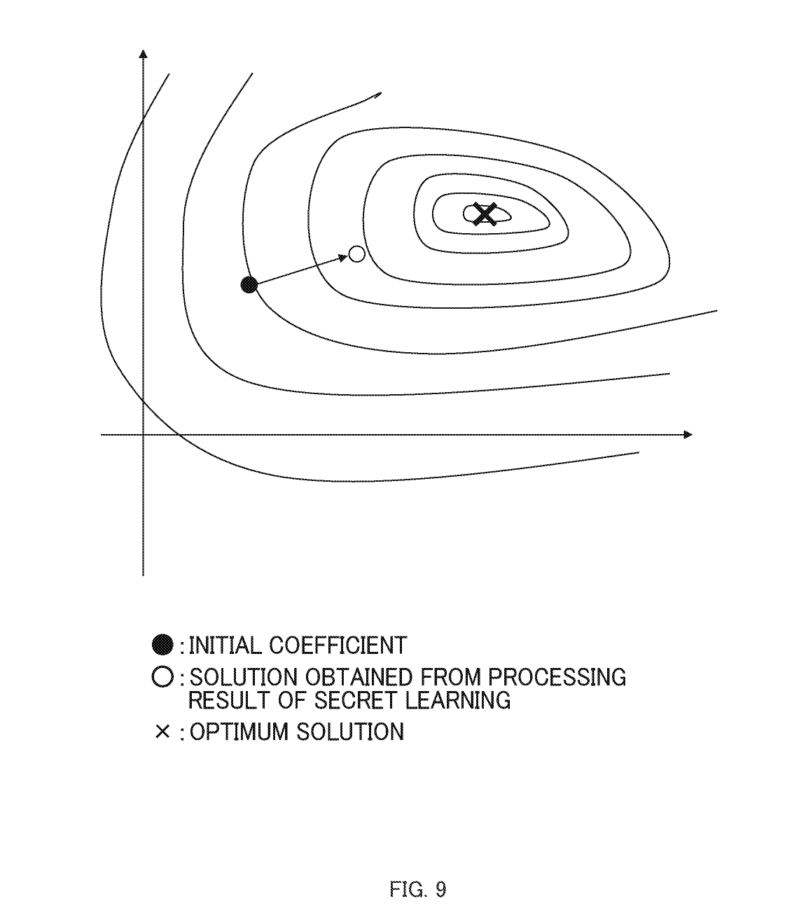

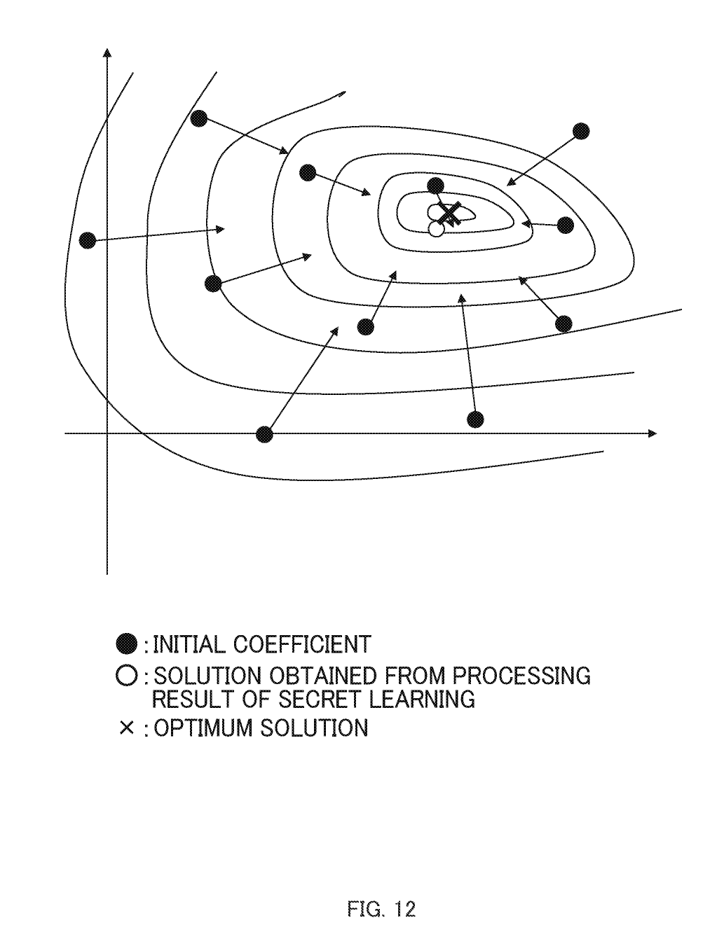

FIG. 12 is a diagram for explaining the update processing in the learning process (S300) in the second embodiment. In the first embodiment, the processing result of the secret learning (D200) is calculated from the update processing of one set of initial coefficients, but in the second embodiment, the processing result of the secret learning (D200) is calculated as the sum of multiple sets of initial coefficients as illustrated in FIG. 12. Hence, compared to the case where the update process is performed only once as in the first embodiment (see FIG. 9), it is possible to obtain a solution closer to the optimum solution. Meanwhile, it is possible to prevent the secret learning data from being decrypted on the analysis executing apparatus 200 side. Thus, it is possible to bring the learning result closer to the optimum solution while concealing the learning data from the analysis executing apparatus 200 side.

As above, the descriptions have been provided for the embodiments of the present invention. However, the present invention is not limited to the embodiments described above, and various modifications may be made within the gist of the present invention.

For example, although each of the analysis requesting apparatus 100 and the analysis executing apparatus 200 includes one Central Processing Unit (CPU) in the embodiments, the present invention is not limited this configuration. For example, at least one of the analysis requesting apparatus 100 and the analysis executing apparatus 200 may include multiple CPUs, servers, hardware processors, microprocessors, microcontrollers or any suitable combination thereof.

In addition, although the sum of the scalar products of the inner products <xᵢ,xⱼ> of the feature vectors is calculated on the right-hand sides of the update formulae (5) to (7), these do not need to be inner products. The update formulae (5) to (7) may be calculated using a general kernel function K(xᵢ,xⱼ) including the inner products.

Moreover, although the update coefficient y is set as y=0.01 in the above embodiments, the update coefficient y does not need to be this value. A value obtained from an existing algorithm for determining update coefficients of the gradient method may be used.

Furthermore, although the number k of initial values of coefficients prepared is determined by the coefficient generating part 222 of the analysis executing apparatus 200 in the second embodiment, the value k may be specified by the analysis requesting apparatus 100. This approach can be implemented by the learning data transmitting part 125, for example, receiving an input of the value k from the user and transmitting the input to the analysis executing apparatus 200 together with the secret learning data.

### REFERENCE SIGNS LIST

100 analysis requesting apparatus
101 CPU
102 auxiliary storage device (storage device)
103 memory
104 internal signal line
105 display device
106 input-output interface
107 communication device
200 analysis executing apparatus
300 network

1. A support vector machine learning system that performs support vector machine learning, comprising:
a learning data management apparatus; and
a learning apparatus coupled to the learning data management apparatus, wherein
the learning data management apparatus comprises:
a learning data storage part that stores a set of learning data including a label and a feature vector, the set of learning data being subjected to the support vector machine learning;
an encryption processing part that encrypts the label of the learning data using an additive homomorphic encryption scheme; and
a learning data transmitting part that transmits encrypted learning data including the encrypted label and the feature vector to the learning apparatus, and wherein
the learning apparatus comprises:
a learning data receiving part that receives the encrypted learning data; and
an update processing part that performs update processing with a gradient method on the encrypted learning data using an additive homomorphic addition algorithm.

2. The support vector machine learning system according to claim 1, wherein
the learning data management apparatus further comprises:
a dummy data addition processing part that adds dummy data to the set of learning data, and
a value of the label included in the dummy data, wherein the value is set to 0.

3. The support vector machine learning system according to claim 1, wherein
the learning apparatus further comprises:
a coefficient generating part that generates initial values of coefficients (a₁, a₂, . . . , a_{N}), which are subjected to the update processing, and wherein
the update processing part generates, as a processing result of the update processing of the support vector machine learning, a set of encrypted texts {E(aᵢyᵢ)|i=1, 2, . . . , N} that are calculated for i=1, 2, . . . , N based on a formula:
$$E ( {a}_{i} {y}_{i} ) ← {a}_{i} E ( {y}_{i} ) - γ ( 2 E ( {y}_{i} ) - 2 {\sum }_{j = 1}^{n} {a}_{j} E ( {y}_{j} ) 〈 {x}_{i} , {x}_{j} 〉 ) ,$$
where xᵢ is the feature vector, yᵢ is the label, and E(yᵢ) is the encrypted label using the additive homomorphic encryption scheme.

4. The support vector machine learning system according to claim 2, wherein
the learning apparatus further comprises:
a coefficient generating part that generates initial values of coefficients (a₁, a₂, . . . , a_{N}), which are subjected to the update processing, and
the update processing part generates, as a processing result of the update processing of the support vector machine learning, a set of encrypted texts {E(aᵢyᵢ)|i=1, 2, . . . , N} that are calculated for i=1,2, . . . , N based on a formula:
$$E ( {a}_{i} {y}_{i} ) ← {a}_{i} E ( {y}_{i} ) - γ ( 2 E ( {y}_{i} ) - 2 {\sum }_{j = 1}^{n} {a}_{j} E ( {y}_{j} ) K ( {x}_{i} , {x}_{j} ) ) ,$$
where xᵢ is the feature vector, yᵢ is the label, E(yᵢ) is the encrypted label using the additive homomorphic encryption scheme.

5. The support vector machine learning system according to claim 1, wherein
the update processing part performs the update processing using each of multiple coefficient groups, which are subjected to the update processing.

6. The support vector machine learning system according to claim 5, wherein
the update processing part sums up processing results of the update processing for each of the multiple coefficient groups and uses the sum as the processing result.

7. A support vector machine learning system that performs support vector machine learning, comprising:
a learning data storage part that stores a set of learning data including a feature vector and a label encrypted using an additive homomorphic encryption scheme, the set of learning data being subjected to the support vector machine learning; and
an update processing part that performs update processing with a gradient method on the encrypted learning data using an additive homomorphic addition algorithm.

8. A support vector machine learning method of performing support vector machine learning executed by a learning data management apparatus that stores a set of learning data including a label and a feature vector, the set of learning data being subjected to the support vector machine learning, comprising:
encrypting the label of the learning data using an additive homomorphic encryption scheme by the learning data management apparatus;
transmitting an encrypted learning data including the encrypted label and the feature vector to a learning apparatus by the learning data management apparatus;
receiving the encrypted learning data by the learning apparatus; and
performing update processing with a gradient method on the encrypted learning data using an additive homomorphic addition algorithm by the learning apparatus.

9. The support vector machine learning method according to claim 8, wherein
the learning data management apparatus further performs a step of adding dummy data to the set of learning data, and
a value of the label included in the dummy data is set to 0.

10. The support vector machine learning system according to claim 1, wherein
the learning apparatus further comprises a coefficient generating part that generates initial values of coefficients (a₁, a₂, . . . , a_{N}), which are subjected to the update processing, and
the update processing part generates, as a processing result of the update processing of the support vector machine learning, a set of encrypted texts {E(aᵢyᵢ)|i=1, 2, . . . , N} that are calculated for i=1, 2, . . . , N based on a formula:
$$E ( {a}_{i} {y}_{i} ) ← {a}_{i} E ( {y}_{i} ) - γ ( 2 E ( {y}_{i} ) - 2 {\sum }_{j = 1}^{n} {a}_{j} E ( {y}_{j} ) K ( {x}_{i} , {x}_{j} ) ) ,$$
where xᵢ is the feature vector, yᵢ is the label, E(yᵢ) is the encrypted label using the additive homomorphic encryption scheme, and K is a kernel function.

11. The support vector machine learning system according to claim 2, wherein
the learning apparatus further comprises a coefficient generating part that generates initial values of coefficients (a₁, a₂, . . . , a_{N}), which are subjected to the update processing, and
the update processing part generates, as a processing result of the update processing of the support vector machine learning, a set of encrypted texts {E(aᵢyᵢ)|i=1, 2, . . . , N} that are calculated for i=1,2, . . . , N based on a formula:
$$E ( {a}_{i} {y}_{i} ) ← {a}_{i} E ( {y}_{i} ) - γ ( 2 E ( {y}_{i} ) - 2 {\sum }_{j = 1}^{n} {a}_{j} E ( {y}_{j} ) K ( {x}_{i} , {x}_{j} ) ) ,$$
where xᵢ is the feature vector, yᵢ is the label, E(yᵢ) is the encrypted label using the additive homomorphic encryption scheme, and K is a kernel function.

12. The support vector machine learning system according to claim 2, wherein
the update processing part performs the update processing using each of multiple coefficient groups, which are subjected to the update processing.

13. The support vector machine learning system according to claim 3, wherein
the update processing part performs the update processing using each of multiple coefficient groups, which are subjected to the update processing.

14. The support vector machine learning system according to claim 4, wherein
the update processing part performs the update processing using each of multiple coefficient groups, which are subjected to the update processing.

15. The support vector machine learning system according to claim 12, wherein
the update processing part sums up processing results of the update processing for each of the multiple coefficient groups and uses the sum as the processing result.

16. The support vector machine learning system according to claim 13, wherein
the update processing part sums up processing results of the update processing for each of the multiple coefficient groups and uses the sum as the processing result.

17. The support vector machine learning system according to claim 14, wherein
the update processing part sums up processing results of the update processing for each of the multiple coefficient groups and uses the sum as the processing result.
